(19) United States
(12) Patent Application Publication
(10) Pub. No.: US 2026/0132830 A1
(43) Pub. Date: May 14, 2026

(54) ACCELERATION-COMPENSATED LOCKING MECHANISM FOR ELECTROMECHANICAL SERVICE BRAKE, ELECTROMECHANICAL SERVICE BRAKE AND METHOD FOR OPERATING A LOCKING MECHANISM

(71) Applicant: Robert Bosch GmbH, Stuttgart (DE)

(72) Inventor: Frank Baehrle-Miller, Schoenaich (DE)

(21) Appl. No.: 19/377,544

(22) Filed: Nov. 3, 2025

(30) Foreign Application Priority Data
Nov. 12, 2024 (DE) 10 2024 210 833.2

(51) Int. Cl. F16D 65/18; F16D 121/24; F16D 127/06

(52) U.S. Cl. CPC F16D 65/18; F16D 2121/24; F16D 2127/06

(57) ABSTRACT

A locking mechanism for locking a release movement for reducing a contact force between two friction partners, of an electromechanical service brake. The locking mechanism including a locking latch that, in a locked state of the locking mechanism, engages the movement of the electromechanical service brake in a locking piece of the electromechanical service brake in a locking manner and, in an unlocked state of the locking mechanism, is arranged so as to release the locking piece; and an actuator for displacing the locking latch between the locked state and the unlocked state.

### FIELD

The present invention relates to a locking mechanism for use in an electromechanical service brake, preferably for use in a motor vehicle. The present invention further relates to an electromechanical service brake having a locking mechanism and to a method for operating a locking mechanism.

### BACKGROUND INFORMATION

In order to implement a parking brake function in electromechanical service brakes, various technical solutions are described in the related art. Germany Patent Application No. DE 10 224 688 A1 describes a method for actuating a parking brake system which is integrated into an electromechanical service brake. In order to apply the parking brake, the electromechanical service brake is actuated by its brake actuator when the vehicle is stationary, and is then locked in the actuated position by a locking mechanism, so that any release movement is locked. The locking mechanism comprises a pawl and a ratchet wheel that is connected to the brake actuator. For locking, the movement of the pawl is released by means of a latch and then the pawl is brought into engagement with the ratchet wheel. The unlocking of the pawl and the actuation of the pawl are each carried out by using an electromagnet. The latch ensures that the pawl does not accidentally engage the ratchet wheel, as could be caused, for example, by vibrations during driving. The disadvantage of this solution is the increased complexity, since two actuators are required to actuate the locking mechanism, which entails increased outlay for cabling, control technology and installation space.

Germany Patent Application No. DE 10 234 848 describes an alternative locking mechanism for fixing an electromechanical service brake. A locking latch is configured to be linearly movable for latching into a ratchet wheel. In order to lock the ratchet wheel, a linear actuator is actuated, so that the locking latch is displaced against a spring force of a return spring into a position that locks the ratchet wheel. The spring force is selected to be large enough to reliably prevent unintentional displacement of the locking latch when an external acceleration acts on the mechanism. Overcoming this strong spring force when activating the locking mechanism requires a strong linear actuator, which is disadvantageous in terms of cost, installation space, mass and electrical power requirements.

An object of the present invention is to provide a locking mechanism, an electromechanical service brake, and a method for operating a locking mechanism, which overcome the aforementioned disadvantages of the related art.

### SUMMARY

A locking mechanism, an electromechanical service brake, and a method for operating the locking mechanism, according to the present invention have the advantages that external accelerations do not cause the locking mechanism to be unintentionally transferred into a locked state. The locking mechanism according to the present invention is advantageously mechanically simple in design, in particular without additional actuators. Furthermore, a particularly powerful actuator is not necessary, which results in a significantly lower effort in terms of the dimensioning of the electronic and/or electrical components. This makes a locking mechanism according to the present invention advantageously compact and lightweight. Consequently, an electromechanical service brake having a locking mechanism according to the present invention is also advantageously simple and compact in design.

A locking mechanism according to an example embodiment of the present invention for locking a movement, in particular a release movement for reducing a contact force between two friction partners, of an electromechanical service brake, preferably for use in a motor vehicle, in particular in a passenger car, comprises a locking latch that, in a locked state of the locking mechanism, engages the movement of the electromechanical service brake in a locking piece of the electromechanical service brake in a locking manner and, in an unlocked state of the locking mechanism, is arranged so as to release the locking piece. Furthermore, the locking mechanism comprises an actuator, in particular an electromagnetic linear actuator or a linear drive, for displacing the locking latch between the locked state and the unlocked state.

According to an example embodiment of the present invention, a lever mechanism, in particular dimensioned so as to compensate for mass, connects the actuator to the locking latch, wherein a lever length effective for the locking latch and a lever length of the lever mechanism effective for the actuator are in such a relationship relative to one another that inertial forces that, due to an external acceleration acting on the locking mechanism, act on the locking latch, the actuator and/or the lever mechanism, are balanced in such a way that the locking latch remains in the unlocked state starting from an unlocked state, regardless of the magnitude and/or direction of the external acceleration. Here, external accelerations are understood to mean accelerations that occur during the operation of a vehicle and act from the outside on a wheel, and on all components on the wheel, including an electromechanical service brake and thus also on a locking mechanism. Such external accelerations can occur, for example, when driving through a pothole and/or when driving over a curb. This can result in accelerations ranging from at least 10 times to 100 times the acceleration due to gravity. Depending on the mass of components accelerated in this way by an external acceleration, forces of varying magnitude act on these components. These forces are referred to here as inertial forces. The term “mass forces” is also commonly used in engineering. These inertial forces are mass-compensated by means of the lever mechanism according to the present invention. The locking latch is advantageously mounted in a linearly movable manner. In the locked state of the locking mechanism, the locking latch is engaged in the locking piece, and in the unlocked state, the locking latch is disengaged from the locking piece. The locking piece of the locking mechanism is preferably a ratchet wheel, which is in particular connected to a spindle drive of an electromechanical service brake for conjoint rotation, so that rotation of the spindle drive can be locked by means of the locking mechanism. The lever mechanism is advantageously dimensioned so that the locking mechanism is stable with regard to external accelerations even in the locked state, so that it remains in the locked state even when subjected to external acceleration starting from the locked state. Here, the friction partners are to be understood as the brake pad and brake disc in the design as a disc brake, or the brake shoe and brake drum in the design as a drum brake. The friction partners are movable relative to one another and are designed to generate a braking force. A release movement is understood to mean a relative movement of the friction partners relative to one another, which reduces the contact force of the friction partners and thus a braking force. In other words, the electromechanical service brake is released by means of the release movement. An electromagnetic linear actuator is advantageously usable as an actuator in a locking mechanism according to the present invention, since it is particularly simple in design and easy to control. A linearly movable armature can be displaced by electromagnetic force and is connected to the lever mechanism.

Advantageous further developments of the locking mechanism according to the present invention are disclosed herein.

In a first preferred embodiment of the locking mechanism of the present invention, a rocker lever rotatably mounted about an axis of rotation can be provided, on which the locking latch and the actuator are articulated on different sides with respect to the axis of rotation, so that inertial forces that act on the locking latch, the actuator, in particular a movable armature, and the rocker lever, due to the external acceleration, generate opposing moments in relation to the axis of rotation. A rocker lever is also known as a double-sided lever and allows for a mechanically advantageous, simple design of the locking mechanism. The rocker lever has an axis of rotation and, starting from the axis of rotation, on two different sides of the lever, articulation points for additional components, here for the locking latch and the actuator. An external acceleration generates inertial forces in the same direction, so that inertial forces that act on opposite sides of the rocker lever, starting from the axis of rotation of the rocker lever, generate opposing moments with respect to the axis of rotation.

In a further example embodiment of the locking mechanism of the present invention, which advantageously develops the above-described embodiment, the lever length effective for the locking latch and the lever length of the rocker lever effective for the actuator can be in such a relationship relative to one another that the opposing moments generate a moment equilibrium in relation to the axis of rotation. The magnitude of an inertial force depends on the mass of the particular accelerated component and on the magnitude of the external acceleration. The inertial forces that act on the locking latch and on the actuator are thus in a fixed relationship relative to one another, since the external acceleration acts equally on the locking latch and on the actuator. This relationship remains constant even during operation of the locking mechanism. By appropriately selecting and matching the effective lever lengths depending on the mass of the locking latch and the movable or accelerated mass of the actuator, it is now possible to achieve moments of equal magnitude. Due to the opposing directions of action of the moments, a moment equilibrium results when the moments are of equal magnitude. Consequently, the rocker lever, on which these moments act and thus the locking mechanism, remains motionless at rest, regardless of the magnitude of external acceleration.

In a further preferred example embodiment of the locking mechanism of the present invention, a damping means can be provided that dampens a movement of the locking mechanism and can in particular be articulated on the locking latch, the actuator or the lever mechanism. The damping means further contributes advantageously to preventing unintentional movement of the locking latch. For example, due to manufacturing tolerances, a perfect moment equilibrium is practically unattainable. The effect of any remaining residual moment can be reduced in a technically advantageous and simple manner by means of the damping means. In the present application, the damping means can exhibit a high damping rate, since high dynamics in the desired movement of the locking mechanism are not necessary for the present application. A damping means can advantageously be designed simply as a friction damper, in particular one integrated into a mounting of the lever mechanism. For example, as a linear guide for the locking latch with increased sliding friction or as a rotary mounting for the axis of rotation with increased friction. The damping means can also be articulated on the lever mechanism as an additional component and, for example, as a fluid damper.

In a further preferred example embodiment of the locking mechanism of the present invention, a spring means can be provided that biases the locking mechanism toward the unlocked state and can in particular be articulated on the locking latch, the actuator or the lever mechanism. A spring means advantageously acts as a simple means in order to transfer the actuator from an activated state to an inactivated state and thus the locking mechanism from the locked to the unlocked state, so that a single-acting actuator can be used advantageously, which significantly simplifies the actuator. In the case of inertial forces that are not fully compensated for, the spring means continues to have a beneficial effect in ensuring the prevention of unintentional movement of the locking mechanism, since it counteracts in particular any residual moment acting on the lever mechanism. Due to a largely complete compensation of the inertial forces, the spring means can exhibit an advantageously low spring constant. The spring means is particularly space-efficient and therefore advantageous when integrated into the actuator, for example as a coil spring acting on the armature and/or locking latch. In an advantageous electromagnetic linear actuator, the spring means generates a spring force opposing the magnetic force, so that the linear actuator is reset to its de-energized state. Alternatively, a spring means can be arranged in a manner concentrically surrounding the locking latch or as an additional component on the lever mechanism. The spring means can be designed in different forms, for example as a helical compression spring, helical extension spring or leaf spring.

In a further example embodiment of the locking mechanism of the present invention, which advantageously develops the above-described embodiment, the spring means can have a spring force that is 1.3 times, preferably 1.2 times, more preferably 1.1 times a tolerance and/or friction-related minimum mechanically required resetting force. A spring force selected to this extent advantageously makes possible a reliable resetting of the locking mechanism from a locked state to the unlocked state. Furthermore, resetting the locking mechanism by means of a spring means as a passive process does not require targeted actuation, which advantageously reduces the effort required for actuators and control technology. In particular, friction in the lever mechanism and/or in the actuator can counteract the resetting process. A further advantage is that the spring force is low compared to the related art, which is why an actuator with low actuation force is sufficient.

In a further preferred example embodiment of the locking mechanism of the present invention, a direction of movement of the locking latch and a direction of movement of the actuator for displacing the locking latch between the unlocked and the locked state can be arranged parallel to one another. A parallel alignment of the direction of movement of the locking latch and the direction of movement of the actuator ensures that inertial forces, due to an external acceleration, act advantageously on the locking latch and actuator in the same way with respect to their directions of movement. This means that an inertial force that acts on the locking latch and an inertial force that acts on the actuator act in equal relative proportions parallel to the directions of movement and transverse to the directions of movement. This applies regardless of the direction of the external accelerations. The compensation of inertial forces thus has an advantageous effect regardless of the direction of an external acceleration.

In a further example embodiment of the locking mechanism of the present invention, which is an alternative to the above-described embodiment, a direction of movement of the locking latch and a direction of movement of the actuator for displacing the locking latch between the unlocked and locked states can be arranged at an angle relative to one another, wherein an angle bisector of the angle is arranged parallel to a main direction of action of the external acceleration. This embodiment can be advantageous depending on a given and/or limited installation space. Here, a main direction of action is understood to mean the direction of action of an external acceleration that occurs most frequently and/or with the greatest magnitude during operation. In relation to a vehicle, the main direction of action of the external acceleration can be advantageously aligned perpendicular to the direction of movement of the vehicle. For example, when driving over a pothole, a vertically upward external acceleration acts on the wheel and an electromechanical service brake having a locking mechanism according to the (present) invention. In relation to this main direction of action, the direction of movement of the locking latch and the direction of movement of the actuator are symmetrically aligned, so that inertial forces occurring in this main direction of action are compensated for by the lever mechanism. In this example embodiment, a spring means and/or a damping means is particularly advantageous, since it prevents unintentional displacement of the locking latch during external acceleration in a direction of action that is substantially different from the main direction of action and the associated incomplete compensation of the inertial forces.

The present invention further relates to an electromechanical service brake, in particular with a function as a parking brake, preferably for use in a motor vehicle, in particular in a passenger car, at least comprising a locking mechanism according to the present invention. In an advantageous example embodiment of the present invention, an electromechanical service brake can comprise a spindle drive by means of which a rotary drive movement can be converted into a translational movement, which is transmitted to the brake pads. In this way, a contact force can be applied by the brake pads to a brake disc by means of the spindle drive. For the advantageously simple integration of a parking brake function into the electromechanical service brake, this comprises a locking mechanism according to the present invention. For this purpose, a ratchet wheel can be connected to a spindle nut of the spindle drive for conjoint rotation as a locking piece, so that when braking force is applied, i.e., the brake is engaged, a rotation of the spindle nut and thus an axial movement of the spindle drive, in particular a release of the brake, can be locked by locking the ratchet wheel by means of the locking latch.

The present invention further relates to a method for operating a locking mechanism for locking a movement, in particular a release movement for reducing a contact force between two friction partners, of an electromechanical service brake, preferably for use in a motor vehicle, in particular in a passenger car. According to an example embodiment of the present invention, in the method, a locking latch, in a locked state of the locking mechanism, engages the movement of the electromechanical service brake in a locking piece of the electromechanical service brake in a locking manner and, in an unlocked state of the locking mechanism, is arranged so as to release the locking piece, further comprising an actuator, in particular an electromagnetic linear actuator or a linear drive, for displacing the locking latch between the locked state and the unlocked state.

According to an example embodiment of the present invention, inertial forces that, due to an external acceleration acting on the locking mechanism, act on the locking latch, the actuator and/or a lever mechanism, which connects the actuator to the locking latch, in particular dimensioned so as to compensate for mass, are balanced by means of a lever length effective for the locking latch and a lever length of the lever mechanism effective for the actuator in such a way that the locking latch remains in the unlocked state starting from an unlocked state, regardless of the magnitude and/or direction of the external acceleration.

In order to avoid unnecessary repetition, reference is made to the above explanations in relation to the locking mechanism, in relation to the advantages of the service brake according to the present invention and the method according to the present invention for operating a locking mechanism.

Device-related features that are disclosed are likewise to be regarded as disclosed in terms of method features, and vice versa.

Further advantages, features, and details of the present invention can be found in the following description of preferred embodiments of the present invention and with reference to the figures.

### BRIEF DESCRIPTION OF THE DRAWINGS

FIG. 1 shows a schematic representation of an electromechanical service brake according to the related art.

FIGS. 2A and 2B show a typical actuator of a locking mechanism in a sectional view.

FIG. 3 shows a locking mechanism according to the present invention in a first example embodiment.

FIG. 4 shows a locking mechanism according to the present invention in a second example embodiment.

### DETAILED DESCRIPTION OF EXAMPLE EMBODIMENTS

Identical elements or elements which have the same function are provided with the same reference signs in the figures.

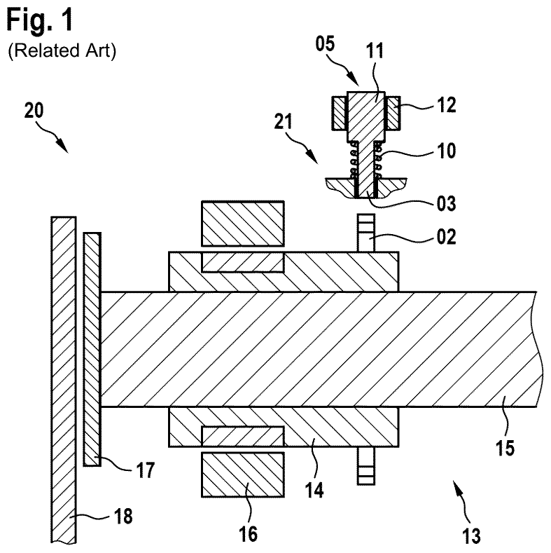

FIG. 1 shows a schematic representation of an electromechanical service brake 20 having a parking brake function according to the related art. A design similar to a floating caliper brake is advantageous. The friction partners are a brake disc 18 and a brake pad 17. To simplify the illustration, a second brake pad is not shown. A spindle drive 13 having a spindle nut 14 and a spindle 15 is designed as a translation-rotation transmission and translates a rotation of the spindle nut 14 into a translational movement of the spindle 15, which brings the brake pad 17 into contact with the brake disc 18 and generates a braking force. A drive moment is applied to the spindle nut 14 by means of an electric motor 16.

In order to integrate a parking brake function, the electromechanical service brake 20 comprises a locking mechanism 21. A ratchet wheel is connected to the spindle nut 14 as a locking piece 02 in a rotationally fixed manner. A locking latch 03 is connected to an armature 11 of a linear actuator 05. When a coil 12 is energized, the armature 11 and thus the locking latch 03 are displaced so that the locking latch 03 engages in a locking manner in the locking piece 02 designed as a ratchet wheel. By means of a spring means 10, the armature 11 and the locking latch 03 are biased toward the unlocked state of the locking mechanism 21, so that when the coil 12 is not energized, the armature 11 and the locking latch 03 are displaced into their initial position, in which the locking latch 03 is arranged to release the locking piece 02 designed as a ratchet wheel, and are held in this position. In order to prevent unintentional displacement of the armature 11 and the locking latch 03, the spring means 10 exhibits a high spring constant.

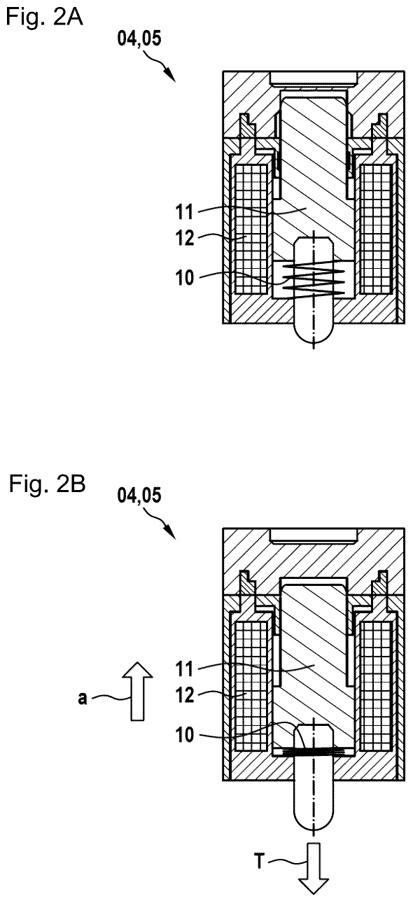

FIGS. 2A and 2B show, by way of example, an electromagnetic actuator 04, here designed as a linear actuator 05. Such a linear actuator 05 is commonly used in a locking mechanism 21 according to the related art and in a locking mechanism 01 according to the present invention. The linear actuator 05 comprises an armature 11 and a coil 12 surrounding the armature 11. The armature 11 is linearly movable between an activated and an inactivated position of the linear actuator 05. FIG. 2A shows the inactivated position. FIG. 2B shows the activated position. Due to the high density of the magnetic material of the armature 11, it has a high mass. When an external acceleration a acts on the linear actuator 05, a high inertial force T acts on the armature 11 due to the high mass of the armature 11. This inertial force T can therefore displace the armature 11 from the inactivated position to the activated position of the linear actuator 05 against a spring force of a spring means 10. It is evident that an external acceleration a can therefore cause an unintentional actuation of a locking mechanism 01, which is connected to the linear actuator 05 or actuated by the linear actuator 05.

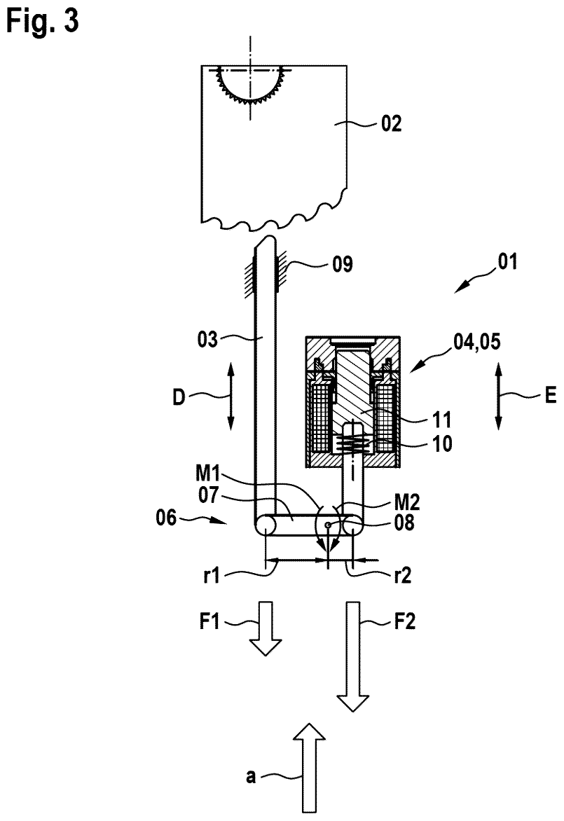

FIG. 3 shows a locking mechanism 01 according to the present invention in a first example embodiment. A locking piece 02 is designed as a ratchet wheel and is connected to a spindle nut (not shown) of an electromechanical service brake for conjoint rotation. In the unlocked state of the locking mechanism 01 shown, the locking latch 03 is disengaged, i.e., the locking latch 03 does not engage with the locking piece 02, and the locking piece 02 is rotatable in both directions. The locking latch 03 is connected to the actuator 04, which is designed as a linear actuator 05, by means of a rocker lever 07. The locking latch 03 is mounted in a linearly movable manner, wherein the mounting of the locking latch 03 makes possible movement of the locking latch 03 in a direction of movement D parallel to a direction of movement E of the linear actuator 05. The mounting of the locking latch 03 can advantageously comprise a damping means (damper) 09, which can be designed, for example, as a friction damper, so that a frictional force counteracts a displacement of the locking latch 03.

A spring means (spring) 10 is designed as part of the actuator 04, so that the locking mechanism 01 is biased in a spring-loaded manner in the direction of an unlocked state. The locking latch 03, the rocker lever 07 and the actuator 04 or the armature 11 of the actuator 04 form a lever mechanism 06. The rocker lever 07 is mounted to rotate about an axis of rotation 08. The rocker lever 07 has a lever length r1 in relation to the locking latch 03. In relation to the actuator 04, the rocker lever 07 has a lever length r2. An external acceleration a generates an inertial force F1 acting on the locking latch 03 and an inertial force F2 acting on the actuator 04. The inertial forces F1, F2 generate opposing moments M1 and M2 acting on the rocker lever 07 with respect to the axis of rotation 08. Here, the armature 11 of the actuator 04 has a larger mass than the locking latch 03, which is why the magnitude of the inertial force F2 is greater than the magnitude of the inertial force F1. The lever length r1 is greater than the lever length r2. The lever lengths r1, r2 are in such a length relationship relative to one another that the opposing moments M1, M2 are of equal magnitude. Consequently, there is a moment equilibrium at the rocker lever 07. Therefore, the lever mechanism 06 remains at rest when being acted upon by an external acceleration a, so that no displacement of the locking latch 03 is caused.

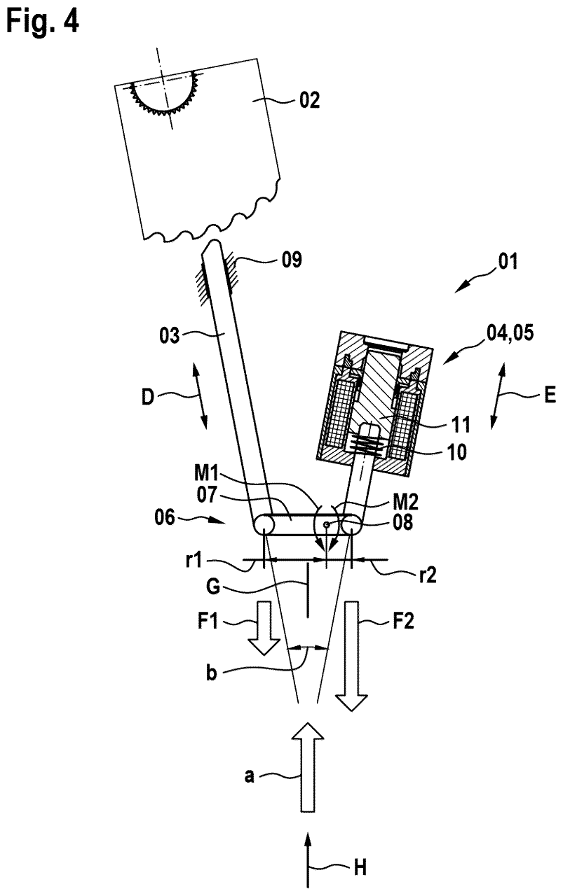

FIG. 4 shows a second embodiment of a locking mechanism 01 according to the present invention. In contrast to the representation in FIG. 3, the locking latch 03 and the linear actuator 05 are arranged at an angle b relative to one another with respect to their directions of movement D, E. The angle b describes the angle between the directions of movement D, E of the locking latch 03 and the linear actuator 05. An external acceleration a acts on the locking mechanism 01 in a main direction of action H. The locking latch 03 and the linear actuator 05 are aligned so that an angle bisector G of the angle b is aligned parallel to the main direction of action H. Consequently, an external acceleration a in the main direction of action H results in a moment equilibrium at the rocker lever 07 with respect to the axis of rotation 08. External accelerations in a direction of action other than the main direction of action H can generate an effective residual moment on the rocker lever 07 with respect to the axis of rotation 08 due to an incomplete balancing of the moments. The spring means is designed so that the spring force of the spring means 10 holds the locking mechanism 01 in the unlocked state against the effect of such a residual moment, so that the effect of such a residual moment does not lead to a displacement of the locking latch 03 from the unlocked state to the locked state of the locking mechanism 01.

1-10. (canceled)

11. A locking mechanism for locking a release movement for reducing a contact force between two friction partners of an electromechanical service brake, comprising:
a locking latch that, in a locked state of the locking mechanism, engages the movement of the electromechanical service brake in a locking piece of the electromechanical service brake in a locking manner and, in an unlocked state of the locking mechanism, is arranged so as to release the locking piece;
an electromagnetic linear actuator or a linear drive, configured to displace the locking latch between the locked state and the unlocked state; and
a lever mechanism, dimensioned so as to compensate for mass, the lever mechanism connecting the actuator to the locking latch, wherein a lever length effective for the locking latch and a lever length of the lever mechanism effective for the actuator are in such a relationship relative to one another that inertial forces that, due to an external acceleration acting on the locking mechanism, act on the locking latch and/or the actuator and/or the lever mechanism, are balanced in such a way that the locking latch remains in the unlocked state starting from the unlocked state, regardless of a magnitude and/or direction of the external acceleration.

12. The locking mechanism according to claim 11, further comprising:
a rocker lever, rotatably mounted about an axis of rotation, on which the locking latch and the actuator are articulated on different sides with respect to the axis of rotation, so that inertial forces that, due to the external acceleration, act on the locking latch, the actuator, and the rocker lever, generate opposing moments in relation to the axis of rotation.

13. The locking mechanism according to claim 12, wherein the lever length effective for the locking latch and the lever length of the rocker lever effective for the actuator are in such a relationship relative to one another that the opposing moments generate a moment equilibrium in relation to the axis of rotation.

14. The locking mechanism according to claim 11, further comprising:
a damper that dampens a movement of the locking mechanism and is articulated on the locking latch or the actuator or the lever mechanism.

15. The locking mechanism according to claim 11, further comprising:
a spring that biases the locking mechanism toward the unlocked state and is articulated on the locking latch or the actuator or the lever mechanism.

16. The locking mechanism according to claim 15, wherein the spring has a spring force that is 1.3 times a tolerance and/or friction-related minimum mechanically required resetting force.

17. The locking mechanism according to claim 11, wherein a direction of movement of the locking latch and a direction of movement of the actuator for displacing the locking latch between the unlocked and the locked state are arranged parallel to one another.

18. The locking mechanism according to claim 11, wherein a direction of movement of the locking latch and a direction of movement of the actuator for displacing the locking latch between the unlocked state and the locked state are arranged at an angle relative to one another, wherein an angle bisector of the angle is parallel to a main direction of action of the external acceleration.

19. An electromechanical service brake having a function as a parking brake, the electromechanical service brake comprising:
a locking mechanism for locking a release movement for reducing a contact force between two friction partners of the electromechanical service brake, the locking mechanism including:
a locking latch that, in a locked state of the locking mechanism, engages the movement of the electromechanical service brake in a locking piece of the electromechanical service brake in a locking manner and, in an unlocked state of the locking mechanism, is arranged so as to release the locking piece;
an electromagnetic linear actuator or a linear drive, configured to displace the locking latch between the locked state and the unlocked state; and
a lever mechanism, dimensioned so as to compensate for mass, the lever mechanism connecting the actuator to the locking latch, wherein a lever length effective for the locking latch and a lever length of the lever mechanism effective for the actuator are in such a relationship relative to one another that inertial forces that, due to an external acceleration acting on the locking mechanism, act on the locking latch and/or the actuator and/or the lever mechanism, are balanced in such a way that the locking latch remains in the unlocked state starting from the unlocked state, regardless of a magnitude and/or direction of the external acceleration.

20. A method for operating a locking mechanism for locking a release movement for reducing a contact force between two friction partners of an electromechanical service brake, the locking mechanism including a locking latch that, in a locked state of the locking mechanism, engages the movement of the electromechanical service brake in a locking piece of the electromechanical service brake in a locking manner and, in an unlocked state of the locking mechanism, is arranged so as to release the locking piece, further including an electromagnetic linear actuator or a linear drive, configured to displace the locking latch between the locked state and the unlocked state, the method comprising:
balancing inertial forces that, due to an external acceleration acting on the locking mechanism, act on the locking latch and/or the actuator and/or a lever mechanism which connects the actuator to the locking latch dimensioned so as to compensate for mass, the inertial forces being balanced using a lever length effective for the locking latch and a lever length of the lever mechanism effective for the actuator in such a way that the locking latch remains in the unlocked state starting from the unlocked state, regardless of a magnitude and/or direction of the external acceleration.
